(19) United States
(12) Patent Application Publication
(10) Pub. No.: US 2008/0201255 A1
(43) Pub. Date: Aug. 21, 2008

(54) FACILITATING CREATION AND SALE OF CARBON CREDITS

(76) Inventor: Mark L. Green, St. Louis, MO (US)

Correspondence Address: HARNESS, DICKEY, & PIERCE, P.L.C, 7700 Bonhomme, Suite 400, ST. LOUIS, MO, 63105, US

(21) Appl. No.: 11/760,577

(22) Filed: Jun. 8, 2007

Related U.S. Application Data
(63) Continuation-in-part of application No. 11/707,847, filed on Feb. 16, 2007.

(51) Int. Cl. G06Q 50/00

(52) U.S. Cl. 705/37

(57) ABSTRACT

A system for facilitating creation and sale of carbon credits. A computer receives data pertaining to a plurality of credit creators and enrolls a plurality of potential and/or actual credits in the system based on the received data. After the enrolling of a credit, the system tracks a plurality of statuses for the enrolled credit, until after the enrolled credit has been sold. The system gathers data relevant to actualization of a potential credit and verifies whether the potential credit has become an actual credit. Access to the tracked statuses for a given credit may be provided to a creator of the credit, an aggregator of the credit, and an exchange.

### CROSS-REFERENCE TO RELATED APPLICATIONS

This application is a continuation-in-part of U.S. patent application Ser. No. 11/707,847 filed on Feb. 16, 2007, the disclosure of which is incorporated herein by reference in its entirety.

### FIELD

The present disclosure relates to environmental resource and/or energy management and more particularly (but not exclusively) to facilitating the establishment of carbon credits by producers and the tracking of carbon credits by producers, aggregators and/or purchasers.

### BACKGROUND

The statements in this section merely provide background information related to the present disclosure and may not constitute prior art.

Carbon credits have come into use as financial derivatives to encourage the reduction of emissions of greenhouse gases such as carbon dioxide (CO2) into the atmosphere. Property owners who can show verifiable reduction in CO2 emissions can qualify for carbon credits. Markets have formed to trade such commodities among buyers and sellers.

### SUMMARY

The present disclosure, in one implementation, is directed to a system for facilitating the creation and sale of carbon credits. At least one processor and memory are configured to receive data pertaining to a plurality of credit creators and enroll a plurality of potential and/or actual credits in the system based on the received data. After the enrolling of a credit, the system tracks a plurality of statuses for the enrolled credit, the tracking performed until after the enrolled credit has been sold. The at least one processor and memory are configured to gather data relevant to actualization of a potential credit and analyze the gathered data to verify whether the potential credit has become an actual credit. Access to the tracked statuses for a given credit is provided to one or more of the following: a creator of the given credit, an aggregator of the given credit, and an exchange.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a flow diagram of a method of facilitating the creation and sale of carbon credits in accordance with one implementation of the disclosure;

FIG. 2 is a block diagram of a system for facilitating the creation and sale of carbon credits in accordance with one implementation of the disclosure; and

FIG. 3 is a flow diagram of a business process flow in accordance with one implementation of the disclosure.

### DETAILED DESCRIPTION

The following description is merely exemplary in nature and is not intended to limit the present disclosure, application, or uses.

The present disclosure, in various implementations, is directed to a system that allows farmers and agriculture property owners to create carbon credits from their farming operations. The credits may be validated for purchase, e.g., by an aggregator or an exchange. In addition, various implementations of the system provide for conversion of output of green energy producing systems to carbon credits. Various implementations can provide a system of record for farmers and buyers of carbon credits.

It should be understood, however, that implementations of the disclosure are not limited to creation of carbon credits in relation to farming operations. The disclosure could be implemented in connection with creation of carbon credits in virtually any environment. Further, carbon credits might be created in more than one way in a particular geographic location. Therefore it is contemplated in various implementations that a given land parcel would not necessarily be limited to the production of a single carbon credit at any one time.

Additionally, although reference is made herein to aggregators and exchanges, it should be understood that in some instances the terms may be interchangeable. An aggregator is typically an intermediary between carbon credit producers and an exchange. An aggregator may pool carbon credits into one or more blocks for purposes of trading the credits on an exchange. In various implementations, however, behavior of a system in accordance with the disclosure with respect to an aggregator may be the same as or similar to behavior of that system relative to an exchange. Accordingly, unless otherwise indicated, references to an “aggregator” may be construed to refer to or include an exchange, and vice-versa.

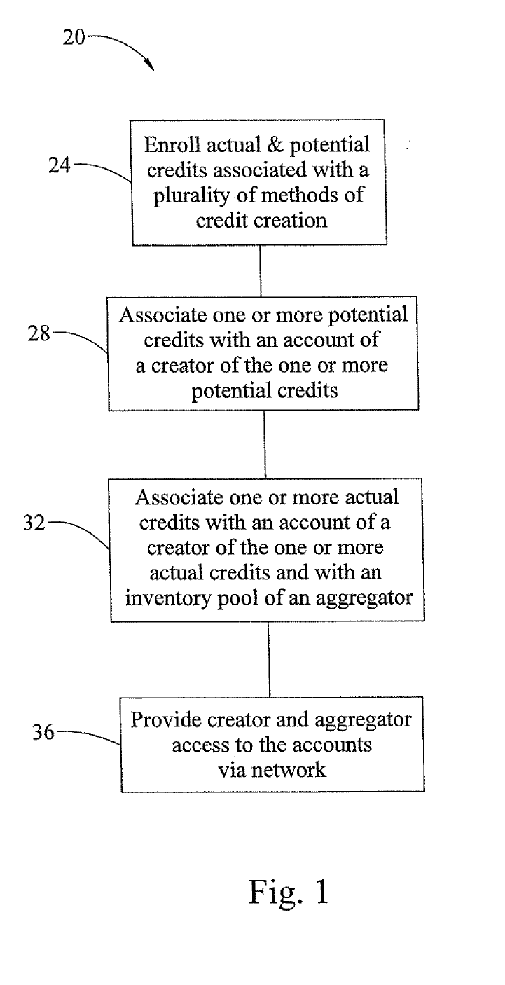

A method of facilitating the creation and sale of carbon credits is indicated generally in FIG. 1 by reference number 20. The method 20 may be performed by one or more processors. In step 24, a plurality of actual and potential credits are enrolled in a data base. The credits are created or creatable, for example, by one or more farmers, using a plurality of methods of credit creation. In step 28, one or more of the potential credits are associated with an account of a creator of the one or more of the potential credits. In step 32, one or more of the actual credits are associated with an account of a creator of the one or more of the actual credits and with an inventory pool of an aggregator. In step 36, creator and aggregator access to the accounts is provided via a network (e.g., the Internet).

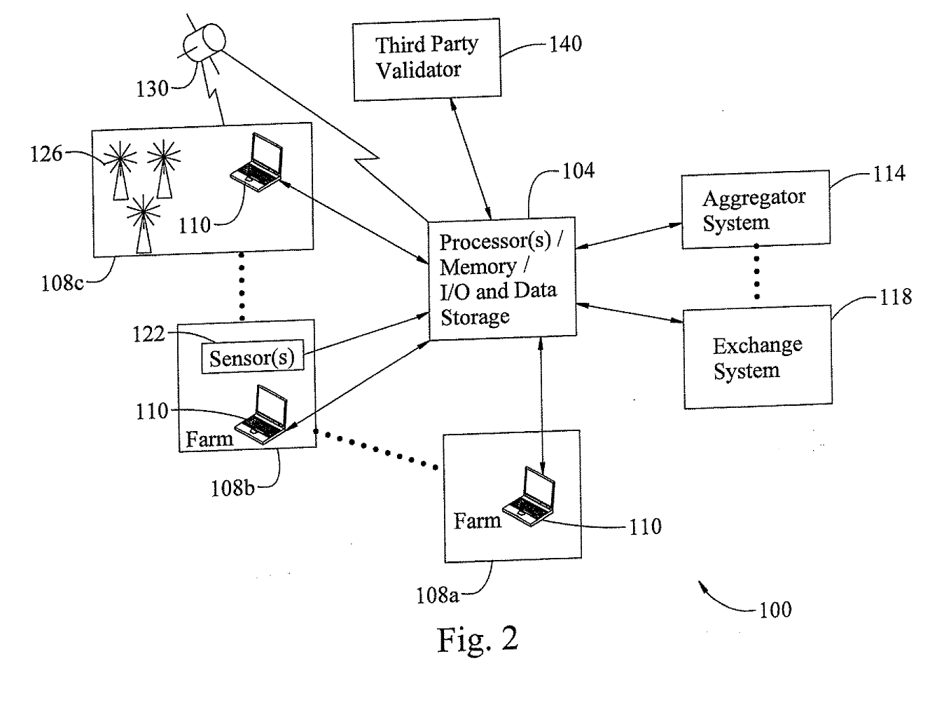

A system for facilitating the creation and sale of carbon credits in one implementation of the disclosure is indicated generally in FIG. 2 by reference number 100. The system 100 includes one or more processors, memory, data storage and input/output ports/device(s), indicated collectively in FIG. 2 by reference number 104 and referred to as computer 104. It should be understood that the computer 104 could have many different configurations and could include components different from and/or in addition to those shown in FIG. 2. Further, the computer 104 could include components distributed in one or more locations remote from other computer 104 component(s). Still further, there could be more than one computer 104 in some configurations. In various implementations the computer 104 includes one or more gateways to a network, e.g., the Internet.

The computer 104 receives data pertaining to a plurality of carbon credit creators, e.g., farmers of one or more farms 108 (three farms 108a, 108b and 108c being shown in FIG. 2). The farmers may transmit such data via their computers 110. The computer 104 also may communicate with one or more carbon credit aggregator systems 114. An aggregator system 114 may communicate with one or more exchange systems 118, at least some of which may also communicate with the computer 104. It should be understood that the system 100 is flexible as to what type of entities may be in communication with the system. In some configurations, for example, only aggregator systems, and not exchange systems, may communicate with the system 100. In other configurations, only exchange systems, and not aggregator systems, may communicate with the system 100.

The computer 104 enrolls a plurality of potential and/or actual carbon credits in the system 100 based on the data received from the farmers. After a carbon credit is enrolled, the system 100 tracks a plurality of statuses for the enrolled credit as further described below. The system 100 may perform the tracking until after the enrolled credit has been sold. The system 100 gathers data relevant to actualization of a potential credit and analyzes the gathered data to verify whether the potential credit has become an actual credit. The system 100 also provides access to the tracked statuses for a given credit to one or more of the following: a creator of the given credit, an aggregator of the given credit, and an exchange.

As mentioned above, the system 100 tracks a plurality of statuses of an enrolled carbon credit. Thus, for example, a credit creator and/or aggregator may check on a verification status of a credit. That is, the creator and/or aggregator may query the system 100 to determine whether the system 100 has verified that a potential credit has become an actual credit. In some implementations, if a potential credit has not yet developed into an actual credit, the creator and/or aggregator may determine from the system 100 how far along the credit may be in the actualization process. Other status information in the system 100 available to a credit creator and/or accumulator with respect to a given carbon credit may include, but is not necessarily limited to, ownership, pooling status, and valuation status.

In various implementations, enrolled carbon credits are searchable by aggregators, e.g., who seek to purchase specific kinds of carbon credits. This capability provides aggregators with flexibility as to what types of carbon credits they may purchase. The system 100 provides a web-based registration point for enrollment of carbon credits, not only by property owners and/or other carbon credit creators, but also by carbon credit aggregators. Thus aggregators may enroll their carbon inventories in the system 100. Further, a farmer and/or other carbon credit creator could enroll in the system 100 a credit already included in a pre-existing inventory of an aggregator.

Carbon credits enrolled in the system 100 may be associated with a plurality of methods of credit creation. For example, a farmer of the farm 108a may wish to obtain a carbon credit by using no-till procedures on a specific parcel of land on the farm 108a. Accordingly, the farmer of the farm 108a sends information to the system 100 useful for locating and identifying the parcel. The system 100 associates the parcel with an enrolled carbon credit as further described below. A farmer of the farm 108b may wish to obtain a carbon credit by using methane recovery procedures. Accordingly, the farmer of the farm 108b registers with the system 100 a property address where the methane recovery is to take place. The farmer also may install methane and/or other sensors 122 for communication with the system 100 and by which the system 100 may monitor the recovery procedure. A farmer of the farm 108c may wish to obtain carbon offsets through use of a plurality of wind turbines 126 on the farm 108c. Accordingly, the farmer of the farm 108c uses his/her computer 110 to send data via the Internet to the computer 104 descriptive of the turbines, including, e.g., their locations, their power rating, etc. The system 100 thus may be used in connection with the creation and sale of a plurality of types of carbon credits, including but not limited to credits created through conservation tillage/carbon sequestration, nutrient management, methane recovery, biotechnology, bio control, nitrogen neutralization, bio fuels, natural gas avoidance monitoring within ethanol, etc.

In addition to or instead of gathering data from sensors 126, the system 100 may gather data in a plurality of other or additional ways to verify whether a potential credit has become an actual credit. For example, a satellite 130 may be used to monitor wind turbines 126, e.g., by acquiring imagery confirming the existence, location(s) and operational status of the turbines. The satellite 130 transmits the monitoring data to the computer 104, which is configured to provide verification as to the status of the turbines. The satellite 130 may be used to monitor the development of other or additional enrolled carbon credits. For example, the satellite 130 may be used to monitor no-till usage of land on the farm 108a in connection with an enrolled carbon credit.

It should be understood that “sensor” is used broadly to refer to and include a wide variety of devices. Such devices may include, e.g., inverters that may be connected in an electrical system to sense energy use, other kinds of energy sensors, temperature sensors, usage meters, light sensors, wind speed and/or direction sensors, motion detectors, heat sensors, water sensors, emission sensors, analog and digital signal receivers, cameras, satellites (e.g., the satellite 130), etc. Reference is made to various systems and methods for facilitating environmental resource and/or energy management on farms, described in co-pending U.S. patent application Ser. No. 11/707,847, entitled “Facilitating Environmental Resource and/or Energy Management on Farms”, filed on Feb. 16, 2007, the disclosure of which is incorporated herein by reference in its entirety.

In addition to (or in some cases, instead of) receiving sensor information, the computer 104 may receive data from a farmer and/or other party affiliated with a farm 108. For example, farmers of the farms 108a, 108b and 108c may use computers 110 to communicate with the computer 104 via the Internet or other network. It also is contemplated that a farmer could convey information to the computer 104 in other ways, for example, by telephone, cell phone, etc. In some implementations, a farmer could convey voice information that would be transcribed into digital form for input to the computer 104.

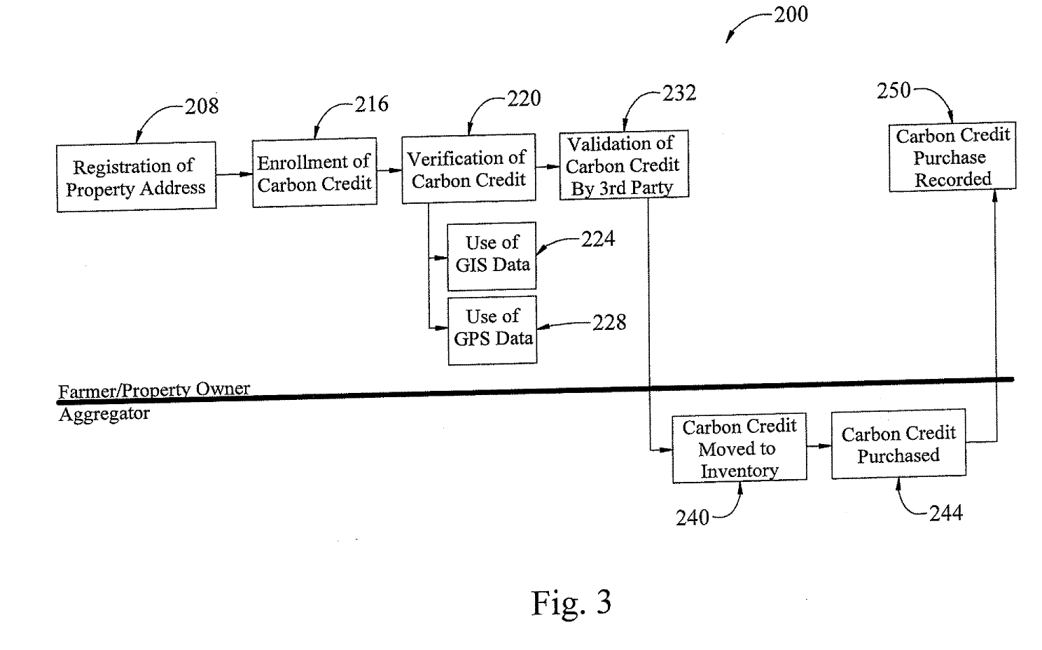

An exemplary business process flow is indicated generally in FIG. 3 by reference number 200. In step 208, a farmer, property owner or other carbon credit creator registers a property address with the system 100 in an account of the creator. In step 216, the creator enrolls an actual or potential carbon credit in the system 100. In step 220, the system 100 verifies a development status of the credit. In the present example, to perform verification, the system 100 in step 224 uses GIS data and in step 228 uses GPS data. The verification status is made available to the credit creator in the account of the creator.

When the credit is verified by the system 100 as being an actual credit, in step 232, and referring also to FIG. 2, the actualization of the credit is validated by an independent third party 140. An independent third party may be, e.g., an organization that physically locates a property associated with the credit and determines whether the credit was actually produced. The third party may record specific details in the system 100 with reference to validation of a carbon credit.

The credit validation is made available through the system 100 to the creator and to an aggregator, e.g., who searches the system 100 for such a credit. In step 240 the aggregator includes the validated credit in its inventory pool. In step 244 the credit is purchased by a purchaser through the aggregator. In step 250 the purchase is recorded in the system 100, in the account of the creator. In some implementations, purchases of carbon credits from the creator may be made by an aggregator or by an exchange. Such purchases also are recorded in the system 100, in the account of the creator.

The system 100 may register a farmer or other carbon credit creator based on a property address. Enrollment of a carbon credit may be based on property address, land parcel description, and/or other identifier that would relate the credit to the registrant. For a carbon credit, e.g., a no-till credit, that is defined with reference to a land parcel description and/or size, the system 100 maintains such information. The system 100 may verify reductions of carbon emissions, for example, by using the Geographic Information System (GIS) and/or Geographic Positioning System (GPS). A carbon credit may be located by gathering and organizing land-related information and by associating that information with the property address and/or GPS coordinates. The system 100 may map the property and/or divide it into agricultural field zones. A property address and/or zones may be defined by longitude/latitude data and/or GPS coordinates. The system 100 may use GIS data layers on top of aerial views of the property and compare multiple data points to verify carbon related information. A GIS record may be created with respect to each agricultural field zone, and fields of relevant agronomic information for that management zone are associated with the record. GIS records associated with the system 100 can be useful in verifying carbon credits. Additionally, means used to gather information for the GIS records can be useful for accumulating carbon credits.

The system 100 uses web services to integrate with aggregator systems 114 and/or exchange systems 118, which may access carbon credit inventory enrolled by aggregators and/or exchanges in the system 100. The system 100 may record carbon trade transaction data from aggregators and/or trading exchanges for carbon ton registered. The system 100 maintains data for a specific carbon credit throughout the life cycle of the carbon credit, e.g., from registration and enrollment, through a purchase of the credit, and through recordation of the purchase transaction in the system 100. The system 100 provides a plurality of search criteria that may be used, e.g., by aggregators and/or exchanges to identify specific types of carbon credits. Thus an aggregator may use purchase-specific criteria to search carbon credit inventory, e.g., where a state utility may want to purchase specific carbon credits from a particular state. A carbon credit creator may enroll a potential credit in the system 100 based on a previously enrolled credit that has been verified and/or validated. The system 100 can confirm and re-register land-based carbon credits, e.g., annually. Credit re-registration may take place automatically. Livestock-based credits, e.g., credits for methane burn-off, may be issued on a per-project basis.

The foregoing systems and methods allow carbon credits to be registered from clean energy technologies through the monitoring of amounts of clean energy produced, at the levels at which they are produced. A “clean energy” technology can be monitored, e.g., by an inverter local to the technology install, to monitor how much clean energy is produced and thus how much CO2 is offset. Farmers, property owners and other carbon creators are able to re-register carbon credit(s) based on their previous carbon credit transactions. A carbon inventory management system can be provided by which aggregators can view and purchase validated carbon credits. Aggregators can enroll farmers or property owners in the foregoing system in order to register the aggregators' carbon credit inventory

The foregoing systems and methods make it possible to streamline virtually all operations for a carbon credit to the point it becomes a financial commodity in an exchange system. Farmers and other would-be creators of carbon credits can be enabled to register, validate, verify and sell carbon credits and thereby take advantage of the emerging carbon credit market. Although carbon credit transactions typically have been complex, manual and time intensive, farmers can now create value from their current operations. Furthermore, a farmer or property owner can adopt farming best practices which lead to carbon credits issuance and an additional revenue stream.

What is claimed is:

1. A system for facilitating the creation and sale of carbon credits, the system comprising at least one processor and memory configured to:
receive data pertaining to a plurality of credit creators;
enroll a plurality of potential and/or actual credits in the system based on the received data;
after the enrolling of a credit, track a plurality of statuses for the enrolled credit, the tracking performed until after the enrolled credit has been sold;
gather data relevant to actualization of a potential credit and analyze the gathered data to verify whether the potential credit has become an actual credit;
provide access to the tracked statuses for a given credit to one or more of the following: a creator of the given credit, an aggregator of the given credit, and an exchange.

2. The system of claim 1, wherein the statuses of a credit comprise a verification status, a validation status, an ownership status, a pooling status, and a valuation status.

3. The system of claim 1, wherein the at least one processor and memory are further configured to:
analyze data gathered relevant to production of green energy; and
verify a carbon credit based on the analysis.

4. The system of claim 1, wherein the at least one processor and memory are further configured to associate an enrolled credit with a plurality of selection criteria by which the credit is selectable by an aggregator or exchange.

5. The system of claim 1, wherein the at least one processor and memory are further configured to enroll a potential credit based on a previously enrolled credit that has been verified.

6. A system for facilitating the creation and sale of carbon credits, the system comprising at least one processor and memory configured to:
include a plurality of actual and potential credits in a data base;
associate each credit with a plurality of selection criteria by which the credit is selectable by an aggregator and/or exchange;
include one or more of the potential credits in an account of a creator of the one or more potential credits; and
include one or more of the actual credits in an account of a creator of the one or more actual credits and in an inventory pool of an aggregator and/or exchange.

7. The system of claim 6, wherein the selection criteria comprise at least one of the following: a credit creation method, and a geographic location associated with the credit.

8. The system of claim 6, further configured to monitor a potential credit to verify creation of an actual credit.

9. The system of claim 6, further configured to:
receive from a third party a validation of an actual credit; and
include the validation in the data base.

10. The system of claim 6, further configured to include one or more credits in the inventory pool based on a specification by the aggregator and/or exchange of one or more of the selection criteria.

11. The system of claim 6, further configured to record in one or more creator accounts a purchase of one or more of the credits.

12. The system of claim 11, further configured to provide web-based communication between one or more creators and an aggregator and/or exchange as to the purchase.

13. The system of claim 11, further configured to provide web-based communication between an aggregator and an exchange as to the purchase.

14. The system of claim 6, further configured to, after actualization of a potential credit, include a subsequent potential credit in the data base.

15. A processor-performed method of facilitating the creation and sale of carbon credits, the method comprising:
enrolling a plurality of actual and potential credits in a data base, the credits associated with a plurality of methods of credit creation;
associating one or more of the potential credits with an account of a creator of the one or more of the potential credits;
associating one or more of the actual credits with an account of a creator of the one or more of the actual credits and with an inventory pool of an aggregator; and
providing creator and aggregator access to the accounts via a network.

16. The method of claim 15, wherein the credit creation methods include one or more of the following: conservation tillage, nutrient management, methane recovery, biotechnology, bio-control, nitrogen neutralization, bio-fuel, and renewable energy.

17. The method of claim 15, further comprising converting green energy into a carbon offset to actualize one of the carbon credits.

18. The method of claim 15, wherein the enrolling is performed as to one or more of the credits based on a request by an aggregator.

19. The method of claim 15, further comprising monitoring development of an actual credit from a potential credit, and providing results of the monitoring in the data base.

20. The method of claim 19, wherein the monitoring is performed using input from at least one of the following: a satellite, and a sensor that provides the input via an internet.

21. A system for facilitating the creation and sale of carbon credits, the system comprising at least one processor and memory configured to:
provide credit accounts to each of a plurality of credit creators and each of one or more aggregators and/or exchanges;
receive from a creator a request to enroll one or more actual and/or potential carbon credits in the creator credit account, at least one of the one or more carbon credits attributable to carbon offset from green energy; and
receive from an aggregator or exchange a selection of at least one of the one or more carbon credits for inventory in the credit account of the aggregator or exchange.

22. The system of claim 21, wherein the at least one processor and memory are further configured to verify actualization of one or more potential credits into one or more actual credits.

23. The system of claim 21, wherein the at least one processor and memory are further configured to receive a validation from a third party of an actual credit, and make the validation available to the one or more aggregators and/or exchanges.

24. The system of claim 21, wherein the at least one processor and memory are further configured to:
receive a request by one of the one or more aggregators and/or exchanges to purchase one of the credits; and
make the purchase request available to a creator of the credit.
